(19) United States
(12) Patent Application Publication
(10) Pub. No.: US 2023/0135400 A1
(43) Pub. Date: May 4, 2023

(54) METHOD AND SYSTEM FOR FACIAL RECOGNITION

(71) Applicant: CANAAN BRIGHT SIGHT CO., LTD., Beijing (CN)

(72) Inventors: Xingang ZHAI, Beijing (CN); Nangeng ZHANG, Beijing (CN)

(21) Appl. No.: 17/918,112

(22) PCT Filed: Nov. 27, 2020
(86) PCT No.: PCT/CN2020/132313

§ 371 Date: Oct. 10, 2022

(30) Foreign Application Priority Data
Apr. 10, 2020 (CN) 202010283208.4

(51) Int. Cl. G06V 40/16; G06V 10/26; G06V 10/771; G06V 10/74; G06V 10/82

(52) U.S. Cl. CPC G06V 40/171; G06V 40/165; G06V 10/26; G06V 10/771; G06V 10/761; G06V 10/82

(57) ABSTRACT

Provided in the present disclosure are a method and system for facial recognition. The method for facial recognition comprises: acquiring an image of an unshielded area of a face; and utilizing the image of the unshielded area of the face for facial recognition.

The present disclosure claims the priority to Chinese Patent Application No. 202010283208.4 filed on Apr. 10, 2020, which is hereby incorporated by reference herein in its entirety.

### TECHNICAL FIELD

The present disclosure relates to the technical field of artificial intelligence, and in particular to a method and system for facial recognition.

### BACKGROUND

The facial recognition technology is a kind of biometric recognition technology for identity recognition based on information on human facial features. The process of facial recognition mainly includes collecting a video stream with a camera, automatically detecting and tracking a human face in an image, and then performing facial recognition on the detected face. With the rapid development of facial recognition technology, the facial recognition system has been widely applied in various fields, such as community access control, company attendance, judicial criminal investigation, etc.

The need for people to wear masks poses a new challenge for scenarios that require facial recognition, such as high-speed rail gates, company attendance, etc. Since the facial area of a person wearing a mask is occluded by the mask in a large area, the existing facial recognition methods cannot accurately detect the position of the face or locate keypoints of the occluded portion of the face, thus greatly reducing the effectiveness of facial recognition.

In addition, if masks are removed for facial recognition in public places, it may pose a risk of infection; and if manual screening is relied upon instead, it may not only require a lot of manpower with a low screening efficiency, but also increases the risk of infection for manual screening staffs.

### SUMMARY

According to an aspect of the present disclosure, provided is a facial recognition method, which includes:
acquiring an image of an unoccluded facial area; and
performing facial recognition with the image of the unoccluded facial area.

Furthermore, acquiring the image of the unoccluded facial area includes:
acquiring a similarity-transformed facial image;
determining a boundary of unoccluded area in the similarity-transformed facial image; and
cutting out the image of the unoccluded facial area based on the boundary of unoccluded area.

Furthermore, acquiring the similarity-transformed facial image includes:
acquiring an original facial image; and
acquiring the similarity-transformed facial image by performing similarity transformation on the original facial image.

Furthermore, the original facial image includes an image portion of an occluded facial area that is a mask-occluded area of a human face, and an image portion of an unoccluded facial area that is an area of the human face other than the mask-occluded area.

Furthermore, acquiring the similarity-transformed facial image by performing similarity transformation on the original facial image includes:
acquiring a plurality of keypoints of the original facial image by using a facial keypoint detection network; and
selecting, from the plurality of keypoints, more than one keypoint within the unoccluded facial area, and acquiring the similarity-transformed facial image by performing similarity transformation on the original facial image.

Furthermore, five keypoints within the unoccluded facial area are selected from the plurality of keypoints, and the five keypoints correspond to a center of a left eyebrow, a center of a right eyebrow, a right corner of a left eye, a left corner of a right eye and a nose bridge, respectively.

Furthermore, the boundary of unoccluded area in the similarity-transformed facial image is determined by the keypoint corresponding to the position of the nose bridge.

Furthermore, performing facial recognition with the image of the unoccluded facial area includes:
extracting facial features from the image of the unoccluded facial area; and
performing the facial recognition based on the facial features extracted from the image of the unoccluded facial area.

Furthermore, extracting facial features from the image of the unoccluded facial area includes:
extracting facial features from the image of the unoccluded facial area by using a feature extraction network.

Furthermore, performing the facial recognition based on the facial features extracted from the image of the unoccluded facial area includes:
constructing a facial feature library; and
performing the facial recognition by comparing the facial features extracted from the image of the unoccluded facial area with the constructed facial feature library.

Furthermore, constructing the facial feature library includes:
acquiring a plurality of similarity-transformed facial images by performing the similarity transformation on a plurality of original facial images, respectively;
determining boundaries of unoccluded areas in the similarity-transformed facial images, respectively;
cutting out images of unoccluded facial areas based on the boundaries of unoccluded areas in the similarity-transformed facial images, respectively; and
extracting facial features from each of the images of unoccluded facial areas by using a feature extraction network.

According to another aspect of the present disclosure, provided is a facial recognition system, which includes:
an acquisition module configured to acquire an image of an unoccluded facial area; and
a facial recognition module configured to perform facial recognition with the image of the unoccluded facial area.

Furthermore, the acquisition module includes:
a similarity transformation unit configured to acquire a similarity-transformed facial image;
a boundary determination unit configured to determine a boundary of unoccluded area in the similarity-transformed facial image; and
a cutting-out unit configured to cut out the image of the unoccluded facial area based on the boundary of unoccluded area.

According to the aforesaid technical solution, the facial recognition method and system of the present disclosure may achieve at least one of the following effects.

(1) By performing similarity transformation and image cropping (cutting-out) on the original image, the present disclosure can effectively improve the accuracy of facial recognition in case the face is partially occluded for example by wearing a mask.

(2) The facial recognition implemented by extracting facial features via deep learning can easily cope with facial recognition tasks in various security levels.

(3) The similarity transformation according to the present disclosure can further reduce the background effect caused by different frame sizes and thus lessen the requirement for the network.

(4) In the present disclosure, the facial recognition is deployed to a number of different deep learning models independently according to different tasks, which has a high replaceability, and thereby avoids wasting arithmetic power and facilitates the intuitive determination of the part of network to be upgraded.

### BRIEF DESCRIPTION OF THE DRAWINGS

FIG. 1 is a flowchart of a facial recognition method according to the present disclosure;

FIG. 2 is a flowchart for acquiring an image of an unoccluded facial area in the facial recognition method according to the present disclosure;

FIG. 3 is a flowchart for acquiring a similarity-transformed facial image in the facial recognition method according to the present disclosure;

FIG. 4 is another flowchart for acquiring a similarity-transformed facial image in the facial recognition method according to the present disclosure;

FIG. 5 is a flowchart for performing facial recognition with the image of the unoccluded facial area in the facial recognition method according to the present disclosure;

FIG. 6 is a flowchart for performing facial recognition based on the facial features extracted from the image of the unoccluded facial area in the facial recognition method according to the present disclosure;

FIG. 7 is a block diagram of a facial recognition system according to the present disclosure;

FIG. 8 is a block diagram of an acquisition module in the facial recognition system according to the present disclosure;

FIG. 9 is a schematic diagram of 68 keypoints of a human face according to the present disclosure;

FIG. 10 is a comparison diagram between an original image and a similarity-transformed image according to the present disclosure;

FIG. 11 is a comparison diagram between an original image, a similarity-transformed image and a cut-out image of the unoccluded facial area according to the present disclosure;

FIG. 12 is a schematic diagram for original facial data according to the present disclosure;

FIG. 13 is a schematic diagram for pre-processed facial data according to the present disclosure;

FIG. 14 is a schematic diagram of a registration process according to the present disclosure; and

FIG. 15 is a schematic diagram of a query process according to the present disclosure.

### DETAILED DESCRIPTION

The facial recognition process is first briefly introduced here to facilitate the understanding of the technical solutions of the present disclosure.

The facial recognition generally includes facial detection, facial feature extraction, and classification of the extracted facial features to complete the facial recognition.

1. Facial Detection

Facial detection refers to a process of finding whether one or more faces are present in any given image and returning the location and range of each face in the image. Algorithms for the facial detection are classified into four categories, which includes a knowledge-based method, a feature-based method, a template-based matching method, and an appearance-based method. With the use of a direct part model (DPM) algorithm (a variable part model) and deep learning convolutional neural networks (CNN), all algorithms for the facial detection may be divided into two general categories, i.e., an algorithm based on rigid templates represented by CNN and Boosting+Features, and an algorithm based on parts model.

2. Facial Feature Extraction

Facial feature extraction refers to a process performed based on the facial detection for acquiring information on facial features in an area where the face is located. The method for extracting facial features include: Eigenface and Principal Component Analysis (PAC). For the deep learning feature extraction, softmax is taken as a cost function to extract a layer of the neural network as features.

3. Classification

Classification refers to a process for classifying the extracted features according to the type, class or nature to accomplish facial recognition. The classification method mainly includes a decision tree method, a Bayesian method, and an artificial neural network.

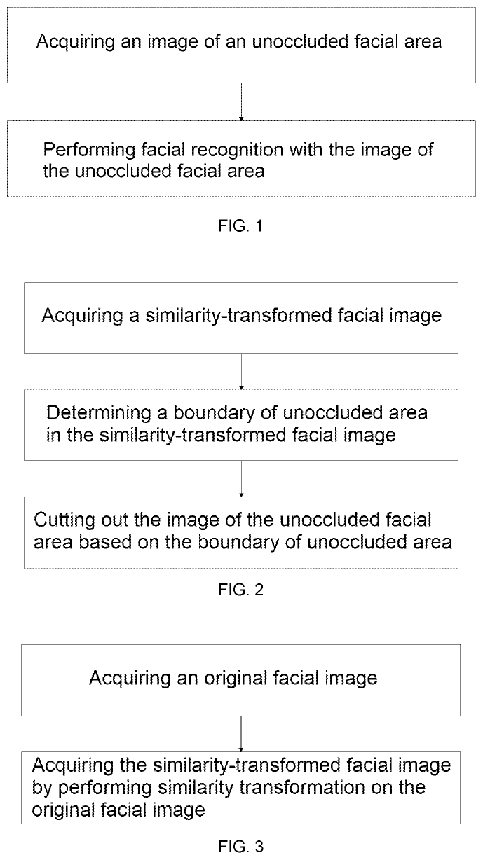

The present disclosure provides a facial recognition method. As shown in FIG. 1, the facial recognition method includes:
acquiring an image of an unoccluded facial area (part); and
performing facial recognition with the image of the unoccluded facial area.

According to the present disclosure, the facial recognition is implemented with the image of the unoccluded facial area. Thus, the accuracy of facial recognition in case the face is partially occluded for example by wearing a mask can be effectively improved compared to the facial recognition implemented by directly adopting the partially occluded facial image.

Specifically, as shown in FIG. 2, acquiring the image of the unoccluded facial area may include:
acquiring a similarity-transformed facial image;
determining a boundary of unoccluded area in the similarity-transformed facial image; and
cutting out the image of the unoccluded facial area based on the boundary of unoccluded area.

More specifically, as shown in FIG. 3, acquiring the similarity-transformed facial image may include:
acquiring an original facial image; and
acquiring the similarity-transformed facial image by performing similarity transformation on the original facial image.

Furthermore, acquiring the similarity-transformed facial image may include: predicting a border of the face by a facial detection network; and acquiring the original facial image by performing the border-based cropping on an output of the facial detection network.

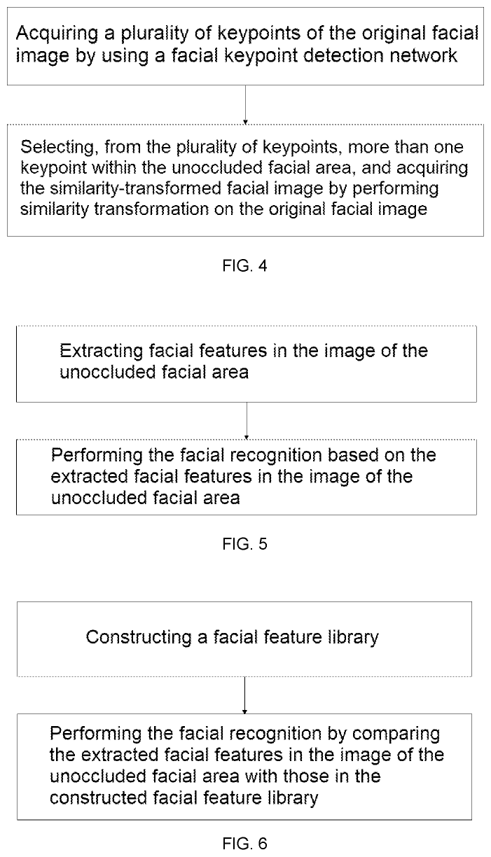

As shown in FIG. 4, acquiring the similarity-transformed facial image by performing similarity transformation on the original facial image may include: predicting a plurality of keypoints of the original facial image by using a facial keypoint detection network; and selecting, from the plurality of keypoints, more than one keypoint within the unoccluded facial area, and acquiring the similarity-transformed facial image by performing similarity transformation on the original facial image.

The similarity transformation according to the present disclosure can further reduce the background effect caused by different frame sizes and thus lessen the requirement for the network.

The original facial image refers to a complete unprocessed image of a human face including both an occluded facial area and an unoccluded facial area. When the facial occlusion is caused by wearing a mask, the occluded facial area is a mask-occluded area of the human face; and accordingly, the unoccluded facial area is an area of the human face other than the mask-occluded facial area. Each of the original facial image, the similarity-transformed facial image and the image of the unoccluded facial area is an image of the person to be recognized currently.

Preferably, five keypoints may be selected from the unoccluded facial area of the original facial image, and the five keypoints correspond to a center of a left eyebrow, a center of a right eyebrow, a right corner of a left eye, a left corner of a right eye and a nose bridge, respectively. In this regard, the boundary of unoccluded area in the similarity-transformed facial image may be determined by the keypoint corresponding to the position of the nose bridge.

Based on this, as shown in FIG. 5, performing facial recognition with the image of the unoccluded facial area may include:
extracting facial features from the image of the unoccluded facial area; and
performing the facial recognition based on the facial features extracted from the image of the unoccluded facial area.

The facial features may be extracted from the image of the unoccluded facial area by using a feature extraction network.

As shown in FIG. 6, performing the facial recognition based on the facial features extracted from the image of the unoccluded facial area may include:
constructing a facial feature library; and
performing the facial recognition by comparing the facial features extracted from the image of the unoccluded facial area with those in the constructed facial feature library.

The facial feature library may be constructed for a plurality of facial images each containing a partially occluded facial area. In particular, the similarity transformation and the cutting out of an image of the unoccluded facial area are performed on the facial images in sequence, and the cut-out images are then respectively inputted into the feature extraction network to extract features. The manner of the similarity transformation and the cropping (cutting-out) is same as that described above, and will not be repeated here. That is, the facial feature library is constructed in the present disclosure with the facial features of the cut-out images of the unoccluded facial area rather than facial features of the whole face as fully exposed or facial features of the whole face as partially occluded. As a result, the facial recognition in the case of wearing a mask can be greatly improved. The original facial image, the similarity-transformed facial image, and the image of the unoccluded facial area may be a plurality of facial images pre-stored as actually desired.

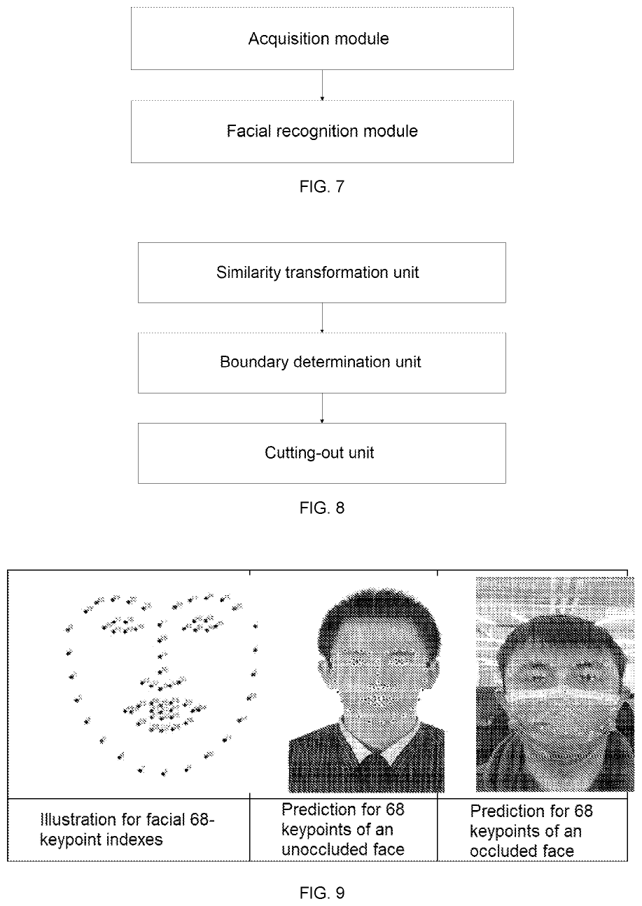

The present disclosure further provides a facial recognition system. As shown in FIG. 7, the facial recognition system includes:
an acquisition module configured to acquire an image of an unoccluded facial area; and
a facial recognition module configured to perform facial recognition with the image of the unoccluded facial area.

As shown in FIG. 8, the acquisition module may include: a similarity transformation unit configured to acquire a similarity-transformed facial image; a boundary determination unit configured to determine a boundary of unoccluded area in the similarity-transformed facial image; and a cutting-out unit configured to cut out the image of the unoccluded facial area based on the boundary of unoccluded area.

Embodiments of the present disclosure will be detailed below in conjunction with FIGS. 9-15.

Most of the solutions in the prior art are targeted to perform facial recognition on faces that are fully exposed (i.e., unoccluded faces), and the accuracy rate decreases by 30% to 40% while performing the facial recognition according to the prior art on the occluded faces (e.g., mask-occluded (i.e., masked) faces).

Specifically, the information available for the facial recognition is significantly reduced because the nose, mouth, and other facial features are occluded when the mask is worn. In addition, the proportion of useful information for the facial recognition is significantly reduced, and the proportion of useless information increases, which further reduces the recognition accuracy. In addition, the keypoint detection network for facial recognition is generally trained based on the whole face that is fully exposed. Thus, the keypoint detection network is rather accurate for predicting keypoints of the unoccluded facial area while being adopted in the facial recognition, but may cause a great extent of drift in predicting keypoints of the occluded facial area, as shown in FIG. 9.

This embodiment provides a facial recognition method, which is well suited for facial recognition scenarios for occluded faces, such as facial recognition scenarios when wearing a mask. The method mainly includes following steps S1-S4.

S1: a similarity-transformed facial image is acquired by performing similarity transformation on the original facial image (i.e., the original image of the whole face wearing the mask, including the mask-occluded facial area and the mask-unoccluded facial area, that is, the part occluded by the mask and the part not occluded by the mask).

Five keypoint indexes (i.e., a center of a left eyebrow, a center of a right eyebrow, a right corner of a left eye, a left corner of a right eye and a nose bridge) are selected from the unoccluded facial area.

KEY_POINTS_CHOOSE_INDEX=[19,24,28,39,42]

The specific settings of the facial size after the similarity transformation in this embodiment are as follows.

fe_imw_temp=128
fe_imh_temp=128

The golden positions corresponding to the 5 keypoint indexes are set as follows:

leb_g=[0.2634073*fe_imw_temp,0.28122878*fe_imh_temp]
reb_g=[0.73858404*fe_imw_temp,0.27334073*fe_imh_temp]
nose_g=[0.515598*fe_imw_temp,0.42568457*fe_imh_temp]
le_g=[0.37369752*fe_imw_temp,0.39725628*fe_imh_temp]
re_g=[0.6743549*fe_imw_temp,0.3715672*fe_imh_temp]
landmark_golden=np.float32([leb_g,reb_g,nose_g,le_g,re_g])

Then, positions of 68 keypoints in the face to be similarly transformed are predicted with a facial 68-keypoint detection network. Assuming output68 is a ratio of the predicted 68 keypoints to the facial size and the coordinates are of the form [x,y], the positions of the five selected keypoints under fe_imw_temp*fe_imh_temp can be acquired as follows:

```
  landmark_get=[ ]
  for_i in range(68):
  if_i in KEY_POINTS_CHOOSE_INDEX:
  landmark_get.append((output68[2*_i+0]*fe_imw_temp,output68[2*_i+1]*fe_imh
_temp))
```

Then, the landmark_get and landmark_golden are adopted for calculating a similarity transformation matrix M as follows:

tform=trans.SimilarityTransform( )
tform.estimate(np.array(landmark_get),np.array(landmark_golden))
M=tform.params[0:2,:]

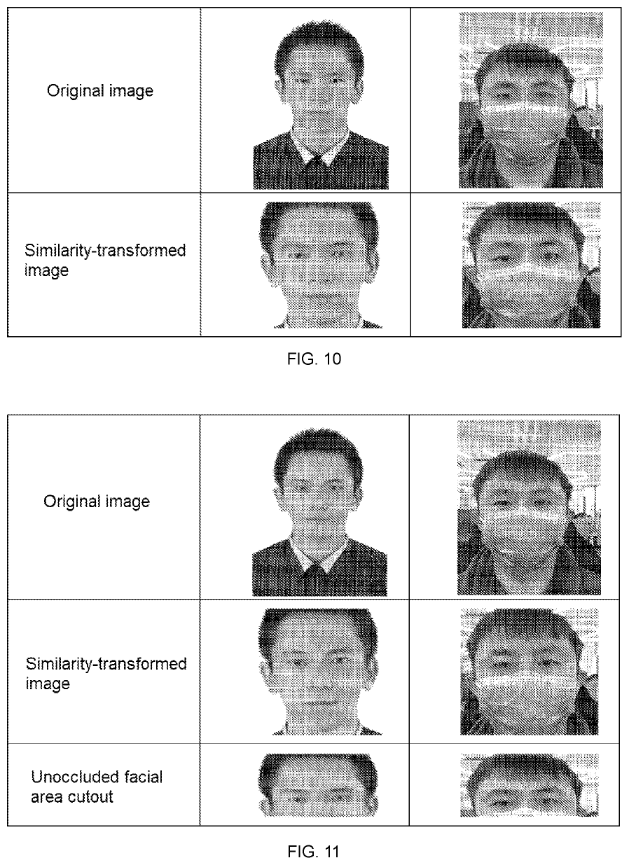

Based on the similarity transformation matrix M, the affine-output may be acquired by performing similarity transformation on the original image img as shown in FIG. 10:

affine_output =
cv2.warpAffine(img,M,(fe_imw_temp,fe_imh_temp),borderValue =0.0)

S2: a boundary of unoccluded area in the similarity-transformed facial image is determined, and an image of the unoccluded facial area is cut out based on the boundary of unoccluded area.

The similarity-transformed facial image acquired after the similarity transformation in step S1 may still retain the mask-occluded facial area (that is, what is acquired is a similarity-transformed image for the whole face including the mask-occluded facial area). In order to remove the mask-occluded facial area of the similarity-transformed image for the whole face, it is necessary to find a lower boundary of the mask-unoccluded facial area therein, and the lower boundary may be determined based on the position of the nose bridge. That is, the lower boundary is namely determined based on the position of the facial 68 keypoint with an index of 28 as shown in FIG. 11:

max_H=landmark_get[2][0]*M[1][0]+landmark_get[2][1]*M[1][1]+M[1][2]
affine_output_crop=affine_output[:int(max_H),:,:]

Afterwards, an image of the mask-unoccluded facial area of the face may be cut out based on the lower boundary.

S3: facial features in the image of the unoccluded facial area are extracted.

The image of the mask-unoccluded facial area as cut out is sent to the feature extraction network, and the facial features are extracted from the image of the mask-unoccluded facial area by using the feature extraction network. Before being sent to the feature extraction network, the image of the unoccluded facial area as cut out is resized to a fixed size, e.g. 64×128 (height×width).

S4: facial recognition is performed based on the facial features extracted from the image of the mask-unoccluded facial area.

The facial features extracted from the image of the mask-unoccluded facial area are compared with the constructed facial feature library to perform the facial recognition.

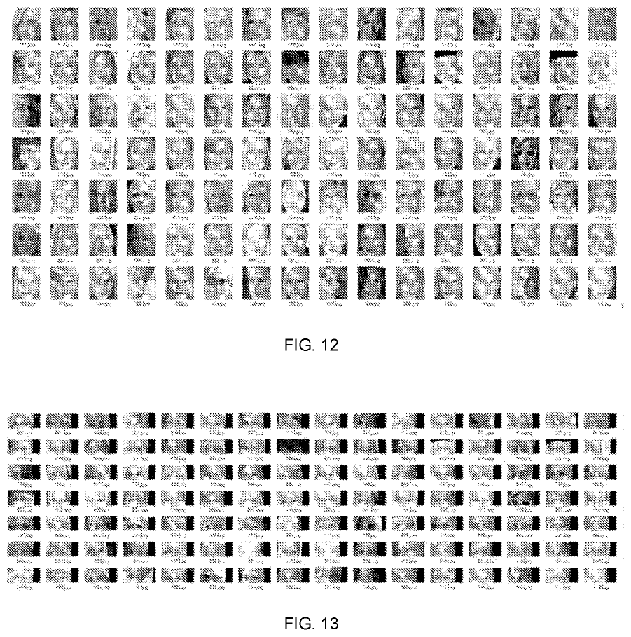

In order to accurately and effectively recognize faces wearing the mask, the keypoint detection network and the feature extraction network as adopted in the facial feature extraction are deep learning artificial neural networks that are acquired by taking the images of unoccluded facial areas (i.e., the images of the mask-unoccluded facial areas shown in FIG. 13 after pre-processing the original facial images shown in FIG. 12 by the similarity transformation) as the training set and the validation set. AM-softmax Loss is selected as a loss function for specific training and validation. The loss function as adopted can reduce the probability of corresponding labeled terms and increase the loss, and thereby is more useful for aggregation of the same class. During the training process of each network, the loss function is continuously reduced and converges to a stable state, and the network in the stable state may be used for keypoint prediction and feature extraction.

As found, the recognition accuracy of this embodiment is about 0.976, which shows that this embodiment significantly improves the recognition accuracy for faces wearing the mask.

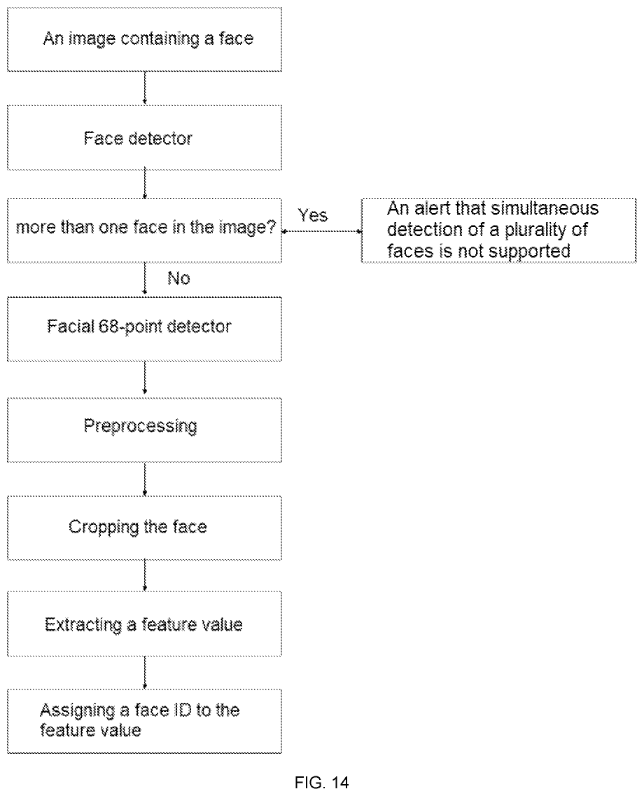

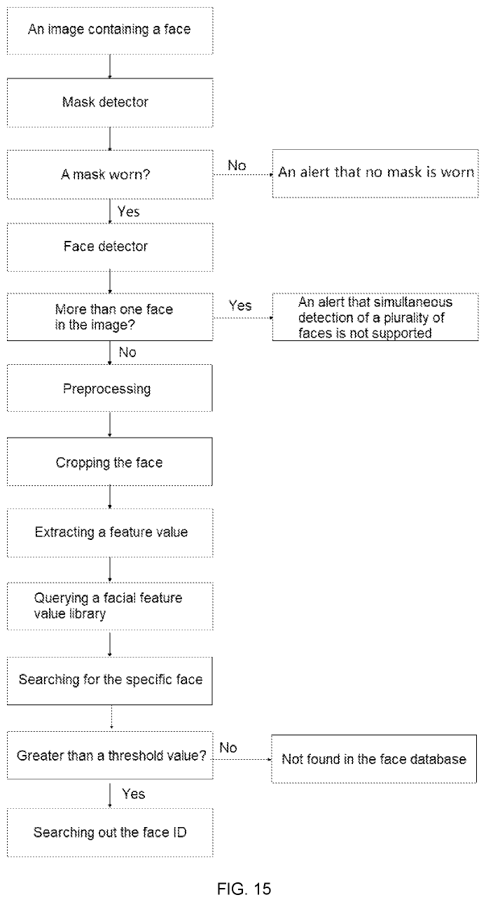

In summary, there are two main processes involved in the practical application, i.e., the registration and query. As shown in FIG. 14, the registration process includes following procedures: an image containing the face is input to a face detector, and if the image includes more than one face, an error is reported and a message of “the image includes more than one face” is output; otherwise, the facial image is sent to a facial 68-keypoint detection network predictor for performing the similarity transformation; after the similarity transformation, an image of the mask-unoccluded facial area is cut out, the feature value thereof is extracted by using a feature extraction network, and a face ID is assigned to the feature value; other facial images are input, and aforesaid steps are repeated. The facial feature value library may be thereby determined. As shown in FIG. 15, the query process includes following procedures: an image containing a face is input to a mask detector; if the face is not wearing a mask, an alarm is generated; otherwise, the image is input to the face detector; whether the image includes more than one face is determined; if so, an error is reported, and otherwise, the similarity transformation and cropping is performed on the facial image for subsequently acquiring the feature value of the image, the procedures of which are similar to the similarity transformation and cropping in the registration process, and thus will not be repeated here; the facial feature value library is queried; and if there is a feature value (greater than a preset minimum threshold) that matches the feature value of the cut-out image, the corresponding ID is acquired, and otherwise, a prompt is output to remind that the feature value is not within the facial feature value library.

Thus far, the present disclosure has been described in detail in conjunction with the accompanying drawings. Based on the aforesaid contents, the skilled person in the art should have a clear understanding of the present disclosure.

It should be noted that the embodiments not illustrated or described in the accompanying drawings or in the body of the specification are in a form known to those of ordinary skill in the art to which they belong and are not described in detail. In addition, the definitions to the components are not limited to the specific structures, shapes or forms mentioned in the embodiments, but can be simply changed or replaced by those of ordinary skill in the art.

Of course, the present disclosure may further include other parts as needed, which are not relevant to the innovation of the present disclosure and will not be repeated here.

Similarly, it should be understood that in the description of exemplary embodiments of the present disclosure, various features of the present disclosure are sometimes grouped together in a single embodiment, figure, or description thereof for the purpose of streamlining the disclosure and helping to understand one or more aspects of the present disclosure. However, the method as disclosed should not be explained to reflect the intent that the present disclosure is intended to the present disclosure as claimed may claim more features than those explicitly recited in each claim. Rather, as reflected by the following claims, the aspect of the present disclosure may be less than all of the features in a single embodiment disclosed above. Thus, claims following embodiments are hereby expressly incorporated into the embodiments, with each claim standing on its own as a separate embodiment of the present disclosure.

Those skilled in the art may understand that the modules in the apparatus in an embodiment may be adaptively changed and provided in one or more apparatuses different from the embodiment. The modules or units or components in the embodiments may be combined into one module or unit or component, and may be furthermore divided into a plurality of sub-modules or sub-units or sub-components. Except combinations where at least some of such features and/or processes or elements are mutually exclusive, all of the features and all of the processes or elements of any method or apparatus disclosed in the present specification (including any accompanying claims, abstract and drawings) may be combined in any combination. Each feature disclosed in the present specification (including any accompanying claims, abstract and drawings) may be replaced by alternative features serving the same, equivalent or similar purpose, unless expressly stated otherwise.

Respective component embodiments of the present disclosure may be implemented in hardware, or in software modules running on one or more processors, or in a combination thereof. Those skilled in the art may understand that a microprocessor or a digital signal processor (DSP) may be adopted in practice to implement some or all functions of some or all components of the relevant devices according to the embodiments of the present disclosure. The present disclosure may also be embodied as apparatus or device programs (e.g., computer programs and computer program products) for performing some or all of the method described herein. Such programs implementing the present disclosure may be stored on a computer readable medium or may have a form of one or more signals. Such a signal may be downloaded from an Internet website or provided on a carrier signal, or in any other form.

Furthermore, sequential terms such as “first”, “second”, “third”, and the like as adopted in the specification and claims to modify the corresponding component does not in itself imply and represent that the component has any sequential order, nor does it represent the order of one component over another, or the order of manufacturing methods. The use of these sequential terms is only intended to enable a component with a certain name to be clearly distinguished from another component with the same name.

In addition, the similar or identical parts are represented by the same reference sign in the accompanying drawings or specification. The technical features of each embodiment exemplified in the specification may be freely combined to form new embodiments without conflict, and each claim may be used individually as an embodiment or the technical features of each claim may be combined as a new embodiment. In addition, the shape or thickness of features of the embodiment may be expanded in the accompanying drawings and shown in a simplified or convenient manner. Further, the components or embodiments not shown or described in the accompanying drawings are known to those of ordinary skill in the art to which they belong. Further, although this specification may provide an illustration of a parameter containing a particular value, it should be understood that the parameter need not be exactly equal to the corresponding value and may approximate the corresponding value within acceptable error tolerances or design constraints.

Unless there are technical obstacles or contradictions, the aforesaid embodiments of the present disclosure may be freely combined to form alternative embodiments, all of which are within the protection scope of the present disclosure.

Although the present disclosure is illustrated in conjunction with the accompanying drawings, the embodiments disclosed in the accompanying drawings are intended to be exemplary illustrations of preferred embodiments of the present disclosure rather than a limitation to the present disclosure. The dimensional proportions in the accompanying drawings are merely schematic and shall not be understood as a limitation to the present disclosure.

Although some embodiments of the general concept of the present disclosure have been shown and illustrated, it will be understood by those of ordinary skill in the art that changes may be made to the embodiments without departing from the principles and spirit of the general concept of the invention, and that the scope of the present disclosure is limited by the claims and their equivalents.

Described above are merely preferred embodiments of the present disclosure, and are not intended to limit the present disclosure. Within the spirit and principles of the disclosure, any modifications, equivalent substitutions, improvements, and the like are within the protection scope of the present disclosure.

What is claimed is:

1. A facial recognition method, comprising:
acquiring an image of an unoccluded facial area; and
performing facial recognition with the image of the unoccluded facial area.

2. The facial recognition method of claim 1, wherein the acquiring an image of an unoccluded facial area comprises:
acquiring a similarity-transformed facial image;
determining a boundary of unoccluded area in the similarity-transformed facial image; and
cutting out the image of the unoccluded facial area based on the boundary of unoccluded area.

3. The facial recognition method of claim 2, wherein the acquiring a similarity-transformed facial image comprises:
acquiring an original facial image; and
acquiring the similarity-transformed facial image by performing similarity transformation on the original facial image.

4. The facial recognition method of claim 3, wherein the original facial image comprises an image portion of an occluded facial area that is a mask-occluded area of a human face, and an image portion of an unoccluded facial area that is an area of the human face other than the mask-occluded area.

5. The facial recognition method of claim 4, wherein the acquiring a similarity-transformed facial image by performing similarity transformation on the original facial image comprises:
acquiring a plurality of keypoints of the original facial image by using a facial keypoint detection network; and
selecting, from the plurality of keypoints, more than one keypoint within the unoccluded facial area, and acquiring the similarity-transformed facial image by performing similarity transformation on the original facial image.

6. The facial recognition method of claim 5, wherein five keypoints within the unoccluded facial area are selected from the plurality of keypoints, and the five keypoints correspond to a center of a left eyebrow, a center of a right eyebrow, a right corner of a left eye, a left corner of a right eye and a nose bridge, respectively.

7. The facial recognition method of claim 6, wherein the boundary of unoccluded area in the similarity-transformed facial image is determined by the keypoint corresponding to a position of the nose bridge.

8. The facial recognition method of claim 1, wherein the performing facial recognition with the image of the unoccluded facial area comprises:
extracting facial features from the image of the unoccluded facial area; and
performing the facial recognition based on the facial features extracted from the image of the unoccluded facial area.

9. The facial recognition method of claim 8, wherein the extracting facial features from the image of the unoccluded facial area comprises:
extracting facial features from the image of the unoccluded facial area by using a feature extraction network.

10. The facial recognition method of claim 8, wherein the performing the facial recognition based on the facial features extracted from the image of the unoccluded facial area comprises:
constructing a facial feature library; and
performing the facial recognition by comparing the facial features extracted from the image of the unoccluded facial area with the constructed facial feature library.

11. The facial recognition method of claim 8, wherein the constructing the facial feature library comprises:
acquiring a plurality of similarity-transformed facial images by performing similarity transformation on a plurality of original facial images, respectively;
determining boundaries of unoccluded areas in the similarity-transformed facial images, respectively;
cutting out images of unoccluded facial areas based on the boundaries of unoccluded areas in the similarity-transformed facial images, respectively; and
extracting facial features from each of the images of unoccluded facial areas by using a feature extraction network.

12. A facial recognition system, comprising:
an acquisition module configured to acquire an image of an unoccluded facial area; and
a facial recognition module configured to perform facial recognition with the image of the unoccluded facial area.

13. The facial recognition system of claim 12, wherein the acquisition module comprises:
a similarity transformation unit configured to acquire a similarity-transformed facial image;
a boundary determination unit configured to determine a boundary of unoccluded area in the similarity-transformed facial image; and
a cutting-out unit configured to cut out the image of the unoccluded facial area based on the boundary of unoccluded area.
